(19) United States
(12) Patent Application Publication
(10) Pub. No.: US 2026/0195564 A1
(43) Pub. Date: Jul. 9, 2026

(54) SYSTEM AND METHOD FOR FEW-SHOT ADAPTIVE TRANSFORMERS ON MANUFACTURING DATA

(71) Applicant: Robert Bosch GmbH, Stuttgart (DE)

(72) Inventors: Chen QIU, Pittsburgh, PA (US); Wan-Yi LIN, Wexford, PA (US); Tim Ralf PYCHYNSKI, Karlsruhe (DE)

(21) Appl. No.: 19/009,161

(22) Filed: Jan. 3, 2025

(51) Int. Cl. G06N 3/0455; G06N 3/047; G06N 3/084; G06N 3/096

(52) U.S. Cl. CPC G06N 3/0455; G06N 3/047; G06N 3/084; G06N 3/096

(57) ABSTRACT

A method for offline training of a transformer model for the ramp-up phase of manufacturing processes, including the steps of utilizing a pre-trained transformer model designed to predict measurements, utilizing categorical embeddings linked to local parameters and numerical embeddings tied to global parameters from initial measurement data, training using an optimizer that minimizes sample data loss through an inner loop algorithm configured to iteratively update local parameters and determine an inner loop loss using query sets, utilizing an outer loop optimization algorithm configured to aggregate these losses across production lines, and during the ramp-up phase, updating final local parameters to minimize losses on sample sets to output a fine-tuned transformer model optimized for real-time application in manufacturing environments.

### TECHNICAL FIELD

The present disclosure relates to a machine learning model, including those that utilize-few shot models.

### BACKGROUND

Generative Pre-trained Transformer (GPT) model is a large language model using a multi-layer transformer architecture that consists of multiple self-attention layers. The GPT model may be trained to predict the next English word token given the previous word tokens. It may be useful on natural language processing (NLP) tasks.

MAML (model agnostic meta-learning) is a meta-learning algorithm that trains a model on a variety of learning tasks such that the trained model learns to be easily fine-tuned to a new task with few data for fine-tuning. The proposed optimization involves an inner loop which updates the model parameters with a few gradient steps on a few samples, and an outer loop optimization which updates the model parameters to be good initializations for various tasks.

ANIL (almost no inner loop) may simplify MAML by removing the inner loop optimization except fort the task-specific head of the model. Most model parameters are shared across different tasks. Making just the task-specific head of the model adaptable enables an efficient model adaptation.

### SUMMARY

A first illustrative embodiment discloses, a computer-implemented method of training a transformer model offline configured to be adaptable to a ramp-up phase of a manufacturing process, the method comprising providing a pre-trained transformer model configured to be trained to predict measurements, obtaining one or more categorical embeddings and numerical embeddings associated with a first set of measurement data, wherein the one or more categorical embeddings are associated with one or more local parameters, wherein the one or more numerical embeddings are associated with one or more global parameters, for each production line associated with the transformer model, training the transformer model offline utilizing an optimizer configured to update both the local parameters and global parameters via minimizing a loss of one or more sample data sets associated with each corresponding production line, wherein minimizing the loss is conducted by executing an inner loop optimization algorithm configured to update the local parameters for each corresponding production line, obtaining an inner loop loss for the corresponding production line utilizing one or more query sets and the updated local parameter for the corresponding production line, repeating the inner loop optimization algorithm and obtaining one or more inner loop loss for each and every production line with updated local parameters, upon completing the inner loop optimization algorithm for each corresponding production line, executing an outer loop optimization algorithm configured to minimize an outer loop loss by aggregating the inner loop loss for each index and updating both the local parameters and the global parameters, during the ramp-up phase, updating one or more final local parameters of the transformer model in response to minimizing a final loss associated with one or more samples sets associated with the production line, and outputting a fine-tuned transformer model utilizing the one or more final parameters.

A second illustrative embodiment discloses a system that includes one or more processors in communication with a plurality of sensors, wherein the one or more processors are programmed to provide a pre-trained transformer model configured to be trained to predict measurements associated with the plurality of sensors, obtain one or more categorical embeddings and numerical embeddings associated with a first set of measurement data, wherein the one or more categorical embeddings are associated with one or more local parameters, wherein the one or more numerical embeddings are associated with one or more global parameters, for each production line associated with the transformer model, train the transformer model offline utilizing an optimizer configured to update both the local parameters and global parameters via minimizing a loss of one or more sample data sets associated with each corresponding production line, wherein minimizing the loss is conducted by executing an inner loop optimization algorithm configured to update the local parameters for each corresponding production line, obtain an inner loop loss for the corresponding production line utilizing one or more query sets and the updated local parameter for the corresponding production line, repeat the inner loop optimization algorithm and obtain one or more inner loop loss for each and every production line with updated local parameters, upon completing the inner loop optimization algorithm for each corresponding production line, execute an outer loop optimization algorithm configured to minimize an outer loop loss by aggregating the inner loop loss for each index and updating both the local parameters and the global parameters, during the ramp-up phase, update one or more final local parameters of the transformer model in response to minimizing a final loss associated with one or more samples sets associated with the production line, and output a fine-tuned transformer model utilizing the one or more final parameters.

A third illustrative embodiment discloses a computer-implemented method of training a transformer model offline configured to be adaptable to a ramp-up phase of a manufacturing process that includes providing a pre-trained transformer model configured to be trained to predict measurements; obtaining one or more categorical embeddings and numerical embeddings associated with a first set of measurement data, wherein the one or more categorical embeddings are associated with one or more local parameters, wherein the one or more numerical embeddings are associated with one or more global parameters; for each production line associated with the transformer model, training the transformer model offline utilizing an optimizer configured to execute one or steps of (i) updating both the local parameters and global parameters via minimizing a loss of one or more sample data sets associated with each corresponding production line, wherein minimizing the loss is conducted by executing an inner loop optimization algorithm configured to update the local parameters for each corresponding production line, wherein the inner loop optimization algorithm includes the steps of (ii) obtaining an inner loop loss for the corresponding production line utilizing one or more query sets and the updated local parameter for the corresponding production line, (iii) for each and every production line, repeating steps (i)-(ii) utilizing updated local parameters for each index, upon completing step (iii), executing an outer loop optimization algorithm configured to minimize an outer loop loss in response to aggregating the inner loop loss for each index and updating both the local parameters and the global parameters, during the ramp-up phase, updating one or more final local parameters of the transformer model in response to minimizing a final loss associated with one or more samples sets associated with the production line, and outputting a fine-tuned transformer model utilizing the one or more final parameters.

### BRIEF DESCRIPTION OF THE DRAWINGS

FIG. 1 is a diagram of an example of a system with a framework for query tasks according to an example embodiment of this disclosure.

FIG. 2A illustrates one example of a transformer model according to an embodiment that may be utilized for manufacturing or assembly of products.

FIG. 2B illustrates an example of global parameters and local parameters in an embodiment of a transformer architecture.

FIG. 3A illustrates inner loop updates utilizing meta-learning algorithms.

FIG. 3B illustrates outer loop updates utilizing meta-learning algorithms.

FIG. 4 illustrates a flow chart associated with the meta-training utilizing global parameters and local parameters with inner and outer loop optimization.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The patent application, with Ser. No. 19/008,929 entitled “SYSTEM AND METHOD FOR ROOT CAUSE ANALYSIS AND PRUNING WITH TRANSFORMERS” combines transformers with novel components (e.g. categorical/continuous input embeddings, section-dependent linear prediction heads) to model sequential manufacturing data for root cause analysis, which is herein incorporated by reference in its entirety. In a production line, a part may be processed by multiple sections and monitored by many sensors in series. In one embodiment, a system and method may have the ability to learn a transformer to model the complicated patterns of the sequential manufacturing data. However, learning transformer models may require many training samples, as it has large capacity. In the ramp up phase of a new production line, only a few samples are collected. Training the transformer model on just a few samples from the new line may suffer from the overfitting, making the model not usable for deployment. This new line may share some common data patterns with other existing production lines but just have a distribution shift controlled by its parameters, its suppliers, and its part types. Such assumptions commonly happen in one production plant, as the plant would expert in similar ranges of products, and very rarely start a brand new production line that the plant has no experience with. To save the time of data collection and overcome the overfitting issue in modeling, the system and method disclosed below may utilize a meta-learning algorithm for learning a few-shot adaptive transformer model on manufacturing data from multiple production lines.

Learning a transformer model on the manufacturing data requires large number of training samples. However, in the ramp up phase of a production line, only a few samples are available and not enough for training a transformer model from scratch. The disclosure below may address such issue by applying a meta-learning algorithm to train the transformer on multiple production lines, such that the trained model learns how to adapt to a new line fast and efficiently.

Compared with MAML, the system may define line-specific categorical embeddings as the adaptive parameters with a consideration of the production line's characteristics and set the other parameters sharable. This setup improves over MAML in terms of training efficiency, since only essential line-specific parameters need to be adapted to a new line while other parameters are reusable.

ANIL may make the head of the model adaptive and other parameters reusable. Instead, the embodiments specify the categorical embeddings for encoding the categorical measurements as adaptive parameters. Our design choice takes the production line's characteristics into account. Each line consists of different machines and each machine has its unique ID. The distribution shift caused by the difference of machines are likely to be represented by their IDs. Therefore, the embodiments may choose to make the categorical embeddings of these IDs adaptive.

In one embodiment, the system may be used to train a transformer model on multiple production lines, such that the transformer model can be easily adapted to any new production line by updating a few specific parameters with a few steps on very few samples. It provides a transformer model that can model the data patterns in the ramp-up phase of a production line. It saves the time and cost of deploying a transformer model on a new production line.

In a production line, the system may have a sequence of sections. Suppose a part is processed by T consecutive sections one by one. Each session produces a long sequence of measurements (including categorical measurements, e.g., the id number of the section, and continuous measurements, e.g., the width of the part) recording the status of the part and the status of the machine. The T sections collectively produces an even longer production sequence of this part.

The transformer f_{θ} predicts the τ measurements at the next section given upstream measurements x_{1:t} (including both categorical values and continuous values) as

$$\text{?} = {f}_{θ} ( {x}_{1 : t} )$$

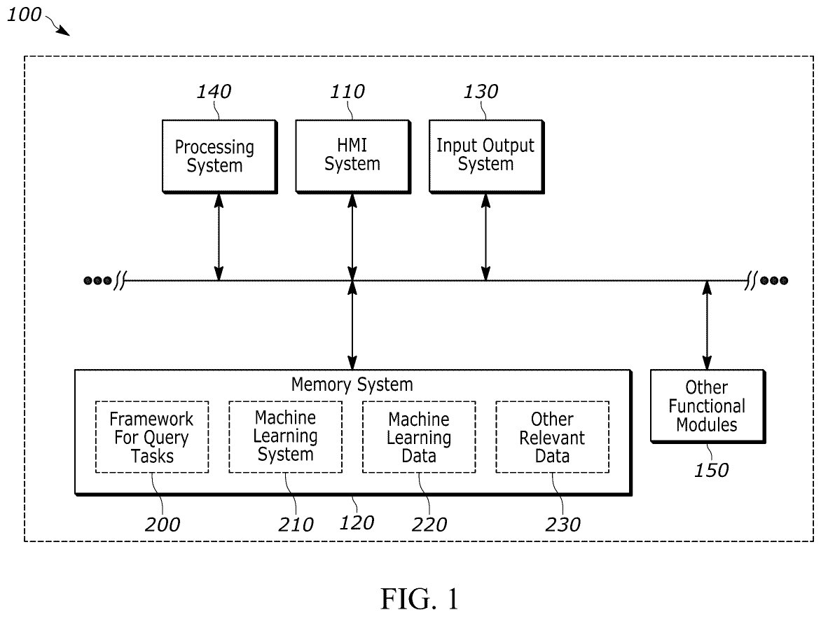

An overview of the model architecture is illustrated in FIG. 1. The transformer f_{θ} consists of categorical/continuous input embeddings, positional embeddings, self-attention modules, and section-dependent linear prediction heads.

Before feeding the measurement values to the self-attention modules, the system may embed the categorical values and continuous values to embedding vectors z∈ [symbol] . The system may embed continuous values with a learnable linear layer with the output dimension of d. Inspired by word2vec, the system may utilize a lookup table that stores learnable embedding vectors with the dimension of d for all categorical values. In summary, the upstream measurements x_{1:t} are first embedded to vectors

$${z}_{1 : t}^{0} .$$

To enable the self-attention modules to capture the sequence's order, it becomes necessary to incorporate information concerning the relative or absolute positions of the input features within the sequence. To achieve this, the system may add positional embeddings to the embeddings

$${z}_{1 : t}^{0}$$

prior to entering the self-attention modules.

The self-attention module consists of a multi-head attention layer (with layer normalization) and a feed-forward network composed of linear layers with GEGLU activations. The detailed calculation of multi-head attention may be known in the art. After passing through L self-attention modules, the system may get embedding vectors

$${z}_{1 : t}^{L} .$$

A linear layer is trained to predict the measurements [symbol] at the next section taking the embedding

$${z}_{t}^{L}$$

as the input. As the sections nave varying numbers of measurements and different context. For each section, the system may learn one linear layer for prediction individually. The output dimension of the linear layer equals the number of measurements at the section.

The training loss is a mean square error averaged over all training samples in the training set D and T time steps, defined as

$${L}_{D} = \frac{1}{\vert D \vert} \frac{1}{T} {\sum }_{i}^{\vert D \vert} {\sum }_{t}^{T} {( \text{?} - {x}_{i , t} )}^{2}$$

In case there may be enough samples from the target line for training, the system may optimize all parameters of the transformer by minimizing training loss on the available training samples.

In the ramp up phase of a new production line, only a few samples are collected. Training the transformer model on just a few samples from the new line may suffer from the overfitting. The new line may share some common data patterns with other existing production lines and have a distribution shift controlled by its machines, its suppliers, and its part types. To save the time of data collection and overcome the overfitting issue, the system may propose a meta-learning algorithm designed for learning a few-shot adaptive transformer model on manufacturing data from multiple production lines.

At inference time when the system may have a new production line, and the system and method may fine-tune the local parameters of the trained model on a few available samples S_{new} from the new line and keep the global parameters unchanged, namely,

$${θ}^{*} = ( {θ}_{g l o bal} , {SGD}_{k} ( {θ}_{local} , {L}_{{S}_{new}} , α ) ) .$$

Since the local parameters are already well-initialized in meta-training, the local parameters can be adapted to fit the new line via just very few update steps (k is very small). Also, since the system and method may only perform very few update steps, the overfitting issue is mitigated.

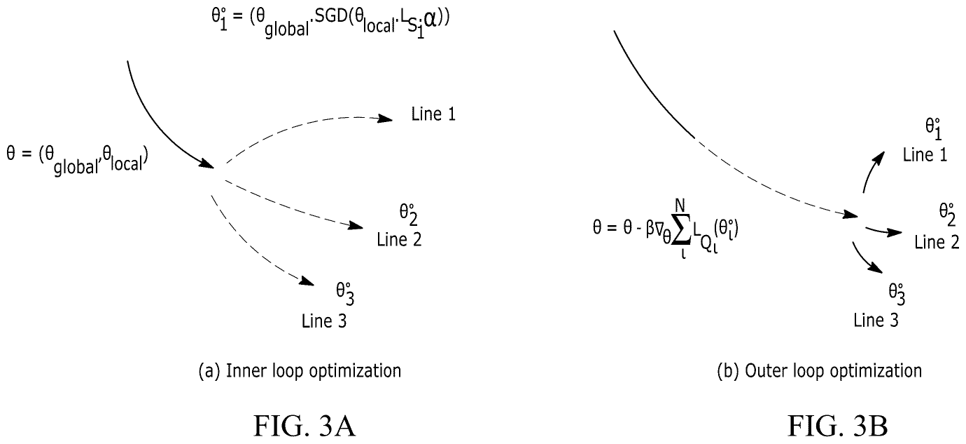

FIG. 1 is a diagram of an example of a system 100 with a neuro-symbolic framework 200 for query tasks according to an example embodiment. The system 100 is configured to pre-train (or train) the machine learning system 210 via the neuro-symbolic framework 200. In addition, the system 100 is an example of a system configured to perform on the machine learning system 210 via the framework 200. After undergoing pre-training (or both pre-training and zero-shot testing), the system 100 may be configured to employ the machine learning system 210 for use. Alternatively, the system 100 may be configured to enable the pre-trained (or pre-trained and zero-shot tested) machine learning system 210 to be employed and/or deployed in another system (e.g. system 300 of FIG. 3) for use.

The system 100 includes at least a processing system 140. The processing system 140 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. The processing system 140 is operable to provide the functionality of the framework 200 and the machine learning system 210, as described herein.

The system 100 includes at least a memory system 120, which is operatively connected to the processing system 140. In an example embodiment, the memory system 120 includes at least one non-transitory computer readable medium, which is configured to store and provide access to various data to enable at least the processing system 140 to perform the operations and functionalities with respect to the framework 200 and corresponding machine learning system 210, as disclosed herein. In an example embodiment, the memory system 120 comprises a single computer readable storage device or a plurality of computer readable storage devices. The memory system 120 can include electrical, electronic, magnetic, optical, semiconductor, electromagnetic, or any suitable storage technology that is operable with the system 100. For instance, in an example embodiment, the memory system 120 can include random access memory (RAM), read only memory (ROM), flash memory, a disk drive, a memory card, an optical storage device, a magnetic storage device, a memory module, any suitable type of memory device, or any number and any combination thereof. With respect to the processing system 140 and/or other components of the system 100, the memory system 120 is local, remote, or a combination thereof (e.g., partly local and partly remote). For example, the memory system 120 can include at least a cloud-based storage system (e.g. cloud-based database system), which is remote from the processing system 140 and/or other components of the system 100.

The memory system 120 includes at least the framework 200, the machine learning system 210, machine learning data 220, and other relevant data 230, which are stored thereon and accessible therefrom. The framework 200 includes computer readable data that, when executed by the processing system 140, is configured to generate at least one training set with a suitable number of query tasks for the machine learning system 210. In addition, the framework 200 includes computer readable data that, when executed by the processing system 140, is configured to implement a zero-shot testing process (or a zero-shot evaluation process) to evaluate the pre-trained (or trained) machine learning system 210 with respect to various commonsense tasks. The computer readable data can include instructions, code, routines, various related data, any software technology, or any number and combination thereof.

In an example embodiment, the machine learning system 210 includes at least one machine learning model. More specifically, the machine learning system 210 includes at least one transformer model. For example, the machine learning system 210 includes a transformer model or any number of transformer models and combination thereof.

In an example embodiment, the machine learning data 220 includes various data, which the framework 200 uses to train, test, and develop the machine teaming system 210. For example, the machine learning data 220 includes a global knowledge graph 220A. The global knowledge graph 220A is generated by combining various knowledge graphs 220B. The machine learning data 220 may also include one or more knowledge bases, which are associated with one or more of the knowledge graphs 220B. The machine learning data 220 also includes a set of commonsense task datasets 220C, which cover a diverse set of tasks. In addition, the machine learning data 220 may also include various annotations, various loss data, various parameter data, as well as any related data that enables the neuro-symbolic framework 200 and the machine learning system 210 to perform the functions as described herein while meeting certain performance criteria. Meanwhile, the other relevant data 230 provides various data (e.g. operating system, etc.), which enables the system 100 to perform the functions as discussed herein.

In an example embodiment, as shown in FIG. 1, the system 100 is configured to include at least one human machine interface (HMI) system 110. The HMI system 110 includes at least one user interface, at least one HMI device, or any number of combination thereof. For example, the HMI system 110 may include a visual user interface, an auditory user interface, a tactile user interface, any suitable user interface, or any number and combination thereof. The HMI system 110 is operable to communicate with the I/O system 130. The HMI system 110 is also operable to communicate with one or more other components (e.g., processing system 140, memory system 120, etc.) of the system 100. More specifically, for example, the processing system 140 is configured to obtain or extract a query or a query task directly or indirectly from the HMI system 110, the memory system 120, and/or the I/O system 130. Upon receiving the query or query task, the processing system 140 is configured to provide a predicted answer to the query or query task via the machine learning system 210.

In addition, the system 100 includes other components that contribute to the training and/or execution of the framework 200 and the machine learning system 210. For example, as shown in FIG. 1, the memory system 120 is also configured to store other relevant data 230, which relates to operation of the system 100 in relation to one or more components (e.g., sensor system 110, I/O system 130, and other functional modules 150). In addition, the VO system 130 may include a VO interface and may include one or more devices (e.g., microphone, keyboard device, touch display device, microphone, mouse, speaker device, etc.). Also, the system 100 includes other functional modules 150, such as any appropriate hardware technology, software technology, or combination thereof that assist with or contribute to the functioning of the system 100. For example, the other functional modules 150 include communication technology that enables components of the system 100 to communicate with each other as described herein. Accordingly, with at least the components shown in FIG. 1, the system 100 is configured to execute the framework 200 to pre-train (or train) the machine learning system 210 to perform well across various query tasks (e.g. question-answering tasks) in a zero-shot setting or when deployed/employed for use in an application.

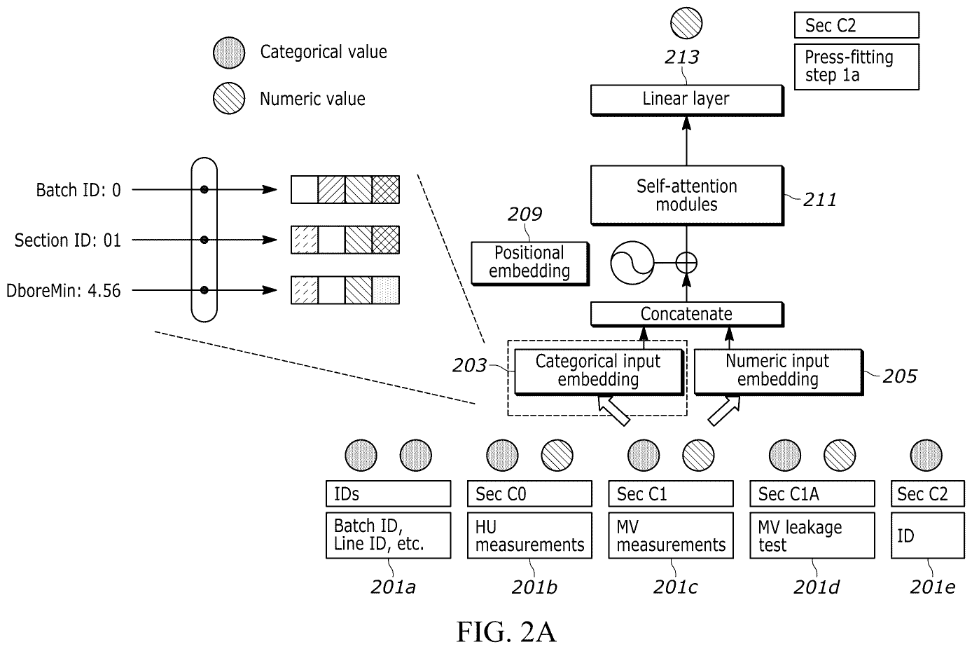

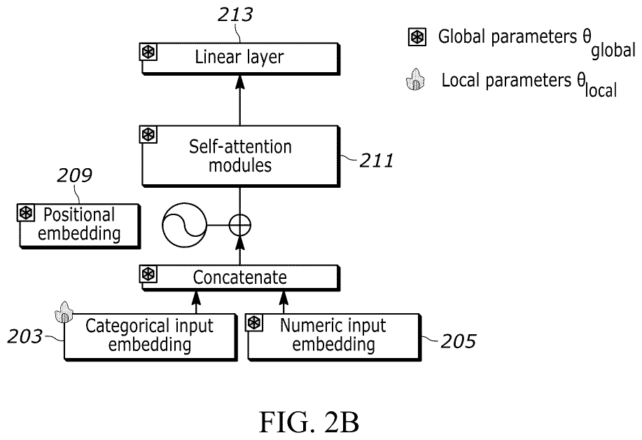

FIG. 2A illustrates one example of a transformer model according to an embodiment that may be utilized for manufacturing or assembly of products. The transformer f consists of sections 201a-201e that contain categorical input embeddings 203 and continuous numeric input embeddings 205, positional embeddings 209, self-attention modules 211, and section-dependent linear prediction heads that are linear layers 213 of each section.

In one model, various stations associated with input embeddings 201a, 201b, 201c, 201d, 201e may be associated with different data. The various stations may be associated with a certain task or category. In one embodiment, a station 201a may include identifications, such as the batch ID or line ID. In another section 201b, the station may obtain handling unit (HU) measurements. In yet another section, station 201c may obtain magnetic values (MV) measurements. In station 201d, station may obtain values associated with magnetic value (MV) leakage test. In yet another embodiment, section 201e may include info associated with the ID.

Before feeding the measurement values to the self-attention modules 211, the system may embed the categorical values and continuous values to embedding vectors z∈ [symbol] . The system may continue embed continuous values with a learnable linear layer with the output dimension of d. Inspired by word2vec, the system may utilize a lookup table that stores learnable embedding vectors with the dimension of d for all categorical values. In summary, the upstream measurements x_{1:T} are first embedded to vectors

$${z}_{1 : T}^{0} .$$

The system may obtain the various measurements and values from the stations and generate corresponding categorical input embeddings 203 and a numeric input embeddings 205. Categorical input embeddings 203 may be derived utilizing a technique used in machine learning, particularly in natural language processing (NLP) and deep learning, to transform categorical data into a numerical format that can be used as input for machine learning models. In one embodiment, One-Hot Encoding may be utilized and each category may be represented as a binary vector, where only one element is “1” (indicating the presence of that category) and all other elements are “0.” This approach can lead to high-dimensional data, especially with a large number of categories. In another embodiment, label encoding may be utilized. In label encoding, each category may be assigned a unique integer value.

To enable the self-attention modules 211 to capture the sequence's order, it becomes necessary to incorporate information concerning the relative or absolute positions of the input features within the sequence. To achieve this, the system and method may add positional embeddings 209 to the embeddings

$${z}_{1 : T}^{0}$$

prior to entering the self-attention modules 211. The positional embeddings 209 may be a vector representing the position of the token in the sequence that is added to the token embedding. This helps the model distinguish between words based on their positions.

FIG. 2B illustrates an example of global parameters and local parameters in an embodiment of a transformer architecture. In one embodiment, the categorical input embedding 205 may utilize a local parameter. The local parameter may be updated during the inner loop optimization algorithm. In another embodiment, the numerical input embedding may include a global parameter. The positional embedding may also utilize global parameters. The global parameters may be fixed during the inner loop optimization algorithm.

Different production lines may share common data patterns since they perform similar manufacturing processes. Different lines may also have different distributions since each consists of different machines. The system may assume the distribution shift can be represented by the categorical nodes associated with each line, including part types, section IDs, batch IDs, and section IDs. The system may define the model parameters θ consisting of local parameters θ_{local} and global parameters θ_{global}. The system may set the parameters of the categorical input embedding as local parameters θ_{local} which should be adapted for each line specifically, as illustrated in FIG. 2A. The system may set other model parameters as global parameters θ_{global} which are shared across different lines. The global parameters are expected to model the data patterns shared among different lines. For example, the system may have new parts with new part IDs (identifications) in the new production line. The new part IDs may need to be encoded by the new line-specific categorical input embedding with adapted local parameters θ_{local}. The numeric measurements and their associated data patterns are shared among many lines. So the numeric measurements can be processed by the global parameters θ_{global} shared among different lines. To learn good global parameters that can be shared among different lines and local parameters that are good initializations for new production lines, the system may use a meta-training algorithm.

FIG. 3A illustrates inner loop updates utilizing meta-learning algorithms. In such an example, three different production lines may be illustrated. It can be assumed that the system may have N production lines, each indexed by i, for training. Each line has a support set of very few samples Sᵢ which are used for inner loop updates and a query set of samples Qᵢ which are used for outer loop updates. Let the meta-transformer model parameter initialization be θ=(θ_{global}, θ_{local}), in the inner loop, the system may update the model parameters θ on the support set Sᵢ of the ith line as

$${θ}^{*} = ( {θ}_{g l o bal} , {SGD}_{k} ( {θ}_{local} , {L}_{{S}_{i}} , α ) )$$

Thus, the first line utilizing the formula above to obtain a parameter. The system may utilize SGDₖ denotes k steps stochastic gradient decent optimizer with a learning rate α. The variable associated with the steps k is usually very small. The optimizer updates the local parameters θ_{local} via minimizing the loss (mean squared error between the predicted and ground truth measurement values) on the support set Sᵢ to fit the target production line. The global parameters θ_{global} are fixed during the inner loop updates. The system perform the inner loop updates on all available production lines and get the updated parameters

$${\{ {θ}_{i}^{*} \}}_{i}^{N}$$

for all lines.

FIG. 3B illustrates outer loop optimization utilizing meta-learning algorithms. In the outer loop optimization, the system may update the model parameters as

$$θ = θ - β {∇}_{θ} {\sum }_{i}^{N} {L}_{{Q}_{i}} ( {θ}_{i}^{*} )$$

$${L}_{{Q}_{i}} ( {θ}_{i}^{*} )$$

may be the loss of the model with the inner loop updated parameters

$${θ}_{i}^{*}$$

on the query set Qᵢ, while the gradient is computed with respect to the model parameters θ before inner loop updates. The learning rate of the outer loop optimization may be defined as β. Both the global parameters and the local parameters are updated in the outer loop, so that the global parameters are optimized to capture the common data patterns, and the local parameters are optimized to be better initializations for different production lines. The first line may utilize the corresponding parameter based on the parameters updated in the outer loop. This may be repeated for each line. (e.g. the second line and third line as illustrated.)

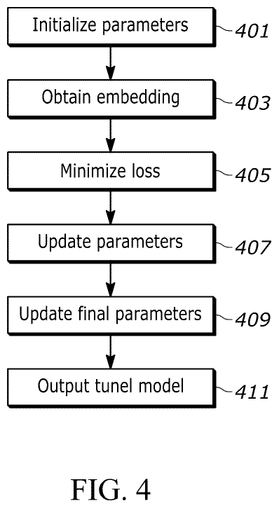

FIG. 4 illustrates a flow chart associated with the meta-training utilizing global parameters and local parameters with inner and outer loop optimization. At a first step 401, the system may randomly initialize the parameters of the model. The model may include global parameters and local parameters. The system and method may provide a pre-trained transformer model that is trained to predict measurements of non-faulty parts. At step 403, the system may obtain one or more categorical embeddings and a numerical embeddings associated with the first set of measurement data, wherein the one or more categorical embeddings are associated with a local parameter. At step 405, the system may, for each production line associated with the transformer model, train the transformer model utilizing an optimizer configured to update the local parameters via minimizing loss of one or more sample data sets associated with a corresponding production line.

At step 407, the system may, in response to updating the local parameters for each corresponding production line, obtain an updated parameter associated with all production lines. Thus, the system may obtain updated parameters for each production line. This may be conducted while the global parameters are fixed.

To make the local parameters (e.g. the categorical input embedding) adaptive efficiently, the system may apply a meta-learning algorithm to train the transformer model on multiple existing production lines. The meta-learning algorithm may be a machine learning algorithm designed to help models learn how to learn. Unlike traditional learning approaches, which focus on training a single task, meta-learning may try to improve a model's ability to adapt quickly to new tasks by leveraging prior experience from related tasks.

The system may optimize the global parameters of the model to a good initialization for different lines such that the model can be adapted to the new line by being fine-tuned with just a few samples. The meta-training procedure may involve one inner loop optimization, and one outer loop optimization.

It can be assumed that the system may have N production lines, each indexed by i, for training. Each line has a support set of very few samples Sᵢ which are used for inner loop updates and a query set of samples Qᵢ which are used for outer loop updates. Let the meta-Transformer model parameter initialization be θ=(θ_{global}, θ_{local}), in the inner loop, the system may update the model parameters θ on the support set Sᵢ of the ith line as

$${θ}_{i}^{*} = ( {θ}_{g l o bal} , {SGD}_{k} ( {θ}_{local} , {L}_{{S}_{i}} , α ) )$$

Where SGDₖ denotes k steps stochastic gradient decent optimizer with a learning rate α. k is usually very small. The optimizer updates the local parameters θ_{local} via minimizing the loss (mean squared error between the predicted and ground truth measurement values) on the support set Sᵢ to fit the target production fit. The global parameters θ_{global} are fixed during the inner loop updates. The system may perform the inner loop updates on all available production lines and get the updated parameters

$${\{ {θ}_{i}^{*} \}}_{i}^{N}$$

for all lines.

At step 409, the system may update one or more final parameters of the transformer model in response to obtaining an inner-loop loss of the transformer model utilizing the updated parameter on a query set. The system may obtain the final parameters once each and every production line has been trained utilizing the outer loop.

In the outer loop optimization, the system may update the model parameters as:

$$θ = θ - β {∇}_{θ} {\sum }_{i}^{N} {L}_{{Q}_{i}} ( {θ}_{i}^{*} )$$

$${L}_{{Q}_{i}} ( {θ}_{i}^{*} )$$

may be the loss of the model with the inner loop updated parameters

$${θ}_{i}^{*}$$

on the query set Qᵢ, while the gradient is computed with respect to the model parameters θ before inner loop updates. The learning rate of the outer loop optimization may be defined as β. Both the global parameters and the local parameters are updated in the outer loop, so that the global parameters are optimized to capture the common data patterns, and the local parameters are optimized to be better initializations for different production lines. At step 411, the system may output a fine-tuned transformer model utilizing the one or more final parameters. For each iteration, the system may focus on the inner loop optimization by updating the parameters on the support set

An example of the meta-training algorithm is defined below:

Algorithm: meta-training

$Require : support sets {\{ {S}_{i} \}}_{i}^{N} and query sets {\{ {Q}_{i} \}}_{i}^{N} of N avaiable lines$
Require: learning rates α, β
1: randomly initialize θ = (θ_{global}, θ_{local})
2: while not done do: (outer loop)
3: for i = 1:N: (inner loop)
$4. update for parameters on the support set as {θ}_{i}^{*} = ( {θ}_{global} , SGD ( {θ}_{local} , {L}_{{S}_{i}} , α ) )$
5: end for
$6. update the model parameters as θ = θ - β {∇}_{θ} {\sum }_{i}^{N} {L}_{{Q}_{i}} ( {θ}_{i}^{*} )$
7: end while

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method of training a transformer model offline configured to be adaptable to a ramp-up phase of a manufacturing process, the method comprising:
providing a pre-trained transformer model configured to be trained to predict measurements;
obtaining one or more categorical embeddings and numerical embeddings associated with a first set of measurement data, wherein the one or more categorical embeddings are associated with one or more local parameters, wherein the one or more numerical embeddings are associated with one or more global parameters;
for each production line associated with the transformer model, training the transformer model offline utilizing an optimizer configured to update both the local parameters and global parameters via minimizing a loss of one or more sample data sets associated with each corresponding production line, wherein minimizing the loss is conducted by executing an inner loop optimization algorithm configured to update the local parameters for each corresponding production line;
obtaining an inner loop loss for the corresponding production line utilizing one or more query sets and the updated local parameter for the corresponding production line;
repeating the inner loop optimization algorithm and obtaining one or more inner loop loss for each and every production line with updated local parameters;
upon completing the inner loop optimization algorithm for each corresponding production line, executing an outer loop optimization algorithm configured to minimize an outer loop loss by aggregating the inner loop loss for each index and updating both the local parameters and the global parameters;
during the ramp-up phase, updating one or more final local parameters of the transformer model in response to minimizing a final loss associated with one or more samples sets associated with the production line; and
outputting a fine-tuned transformer model utilizing the one or more final parameters.

2. The method of claim 1, wherein the method involves freezing one or more global parameters when offline for the transformer model, and not freezing one or more global parameters during the ramp-up phase.

3. The method of claim 1, wherein the method includes freezing one or more global parameters during offline of the transformer model.

4. The method of claim 1, wherein the optimizer is configured to update the local parameters when the global parameters are fixed.

5. The method of claim 1, wherein the query set is associated with the outer loop optimization algorithm and a support set is associated with the inner loop optimization algorithm.

6. The method of claim 1, wherein the production line includes a plurality of production lines.

7. The method of claim 1, wherein the optimizer is a stochastic gradient decent optimizer with an associated learning rate.

8. A system, comprising:
one or more processors in communication with a plurality of sensors, wherein the one or more processors are programmed to:
provide a pre-trained transformer model configured to be trained to predict measurements associated with the plurality of sensors;
obtain one or more categorical embeddings and numerical embeddings associated with a first set of measurement data, wherein the one or more categorical embeddings are associated with one or more local parameters, wherein the one or more numerical embeddings are associated with one or more global parameters;
for each production line associated with the transformer model, train the transformer model offline utilizing an optimizer configured to update both the local parameters and global parameters via minimizing a loss of one or more sample data sets associated with each corresponding production line, wherein minimizing the loss is conducted by executing an inner loop optimization algorithm configured to update the local parameters for each corresponding production line;
obtain an inner loop loss for the corresponding production line utilizing one or more query sets and the updated local parameter for the corresponding production line;
repeat the inner loop optimization algorithm and obtain one or more inner loop loss for each and every production line with updated local parameters;
upon completing the inner loop optimization algorithm for each corresponding production line, execute an outer loop optimization algorithm configured to minimize an outer loop loss by aggregating the inner loop loss for each index and updating both the local parameters and the global parameters;
during the ramp-up phase, update one or more final local parameters of the transformer model in response to minimizing a final loss associated with one or more samples sets associated with the production line; and
output a fine-tuned transformer model utilizing the one or more final parameters.

9. The system of claim 8, wherein one or more global parameters are fixed during the inner loop optimization algorithm.

10. The system of claim 8, wherein one or more global parameters are not fixed during the outer loop optimization algorithm.

11. The system of claim 8, wherein the optimizer is a stochastic gradient decent optimizer with an associated learning rate.

12. The system of claim 8, wherein the plurality of sensors includes image sensors or laser measurement sensors.

13. The system of claim 8, wherein the processor is programmed to update the one or more final local parameters according utilizing an equation defined as
$$θ = θ - β {∇}_{θ} {\sum }_{i}^{N} {L}_{{Q}_{i}} ( {θ}_{i}^{*} ) .$$

14. A computer-implemented method of training a transformer model offline configured to be adaptable to a ramp-up phase of a manufacturing process, the method comprising:
providing a pre-trained transformer model configured to be trained to predict measurements;
obtaining one or more categorical embeddings and numerical embeddings associated with a first set of measurement data, wherein the one or more categorical embeddings are associated with one or more local parameters, wherein the one or more numerical embeddings are associated with one or more global parameters;
for each production line associated with the transformer model, training the transformer model offline utilizing an optimizer configured to execute one or steps of:
(i) updating both the local parameters and global parameters via minimizing a loss of one or more sample data sets associated with each corresponding production line, wherein minimizing the loss is conducted by executing an inner loop optimization algorithm configured to update the local parameters for each corresponding production line, wherein the inner loop optimization algorithm includes the steps of:
(ii) obtaining an inner loop loss for the corresponding production line utilizing one or more query sets and the updated local parameter for the corresponding production line;
(iii) for each and every production line, repeating steps (i)-(ii) utilizing updated local parameters for each index;
(iv) upon completing step (iii), executing an outer loop optimization algorithm configured to minimize an outer loop loss in response to aggregating the inner loop loss for each index and updating both the local parameters and the global parameters;
during the ramp-up phase, updating one or more final local parameters of the transformer model in response to minimizing a final loss associated with one or more samples sets associated with the production line; and
outputting a fine-tuned transformer model utilizing the one or more final parameters.

15. The computer-implemented method of claim 14, wherein one or more global parameters are fixed during the ramp-up phase.

16. The computer-implemented method of claim 14, wherein one or more global parameters are fixed during the inner loop optimization algorithm and the offline phase of the transformer model.

17. The computer-implemented method of claim 14, wherein updating one or more final local parameters of the transformer model is associated with each and every production line.

18. The computer-implemented method of claim 14, wherein executing an outer loop optimization algorithm.

19. The computer-implemented method of claim 14, wherein one or more global parameters are associated with one or more positional embeddings associated with the transformer model.

20. The computer-implemented method of claim 14, wherein one or more global parameters are associated with a linear layer of the transformer model.
